(19) United States
(12) Patent Application Publication
(10) Pub. No.: US 2003/0003829 A1
(43) Pub. Date: Jan. 2, 2003

(54) Laminated cloth having a compressibility

(76) Inventor: Chung-Hu Hsiao, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/918,472

(22) Filed: Aug. 1, 2001

(30) Foreign Application Priority Data
Jun. 28, 2001 (TW) 90210844

(51) Int. Cl. B32B 3/00; B32B 27/14; B32B 27/12; B32B 5/26

(52) U.S. Cl. 442/286; 428/198; 428/195

(57) ABSTRACT

A compressible laminated cloth comprises a fabric main body and an outer layer. The fabric main body comprises a first sheet layer, a second sheet layer, and a support layer sandwiched between the first sheet layer and the second sheet layer. The fabric main body is integrally made by woofing. The outer layer is adhered to the surface of the fabric main body and is made of a cloth of any material, or a sheet of a plastic or rubber material.

### FIELD OF THE INVENTION

The present invention relates generally to a cloth, and more particularly to a laminated cloth having a compressibility.

### BACKGROUND OF THE INVENTION

The conventional compressible composite cloth is generally formed by three modes. The one mode includes a knitted cloth which is attached with a foam elastic thin sheet. The elastic thin sheet is made of various materials, such as artificial sponge, EVA copolymer, natural rubber, synthetic rubber, etc. The elastic thin sheet serves to provide an elasticity against the compression. The artificial sponge is susceptible to deteriorating and aging. The EVA or rubber material is not permeable to air and is devoid of an excellent softness.

The second mode involves a sandwich compressible composite cloth which is integrally made by warping. This structure is relatively less susceptible to deteriorating and aging and is permeable to air. In addition, this structure has a better textural strength. However, this structure is less cost-effective in view of the fact that it is made by warping. In addition, the product selectivity is often limited by the warping of threads due to the fact that the shape and the pattern of the product are limited by the warping of threads.

Another kind involves the use of a knitted fabric layer which is provided thereon with a fiber support layer slightly perpendicular to the knitted fabric layer. The fiber support layer is provided thereon with another knitted fabric layer. The support layer is intended to provide an elasticity against compression. This structure is relatively more cost-effective and is less limited in formation of texture shape and pattern of the product. The production involves the pressing, thereby making the product vulnerable to stripping, as compared with the product which is made integrally. The cloth of this kind of structure is used as a filler.

### SUMMARY OF THE INVENTION

The primary objective of the present invention is to provide a laminated cloth which has a compressibility and is permeable to air.

In keeping with the principle of the present invention, the foregoing objective of the present invention is attained by a compressible laminated cloth having a fabric main body comprising a first sheet layer, a second sheet layer, and a support layer sandwiched between the first sheet layer and the second sheet layer. The first sheet layer, the support layer, and the second sheet layer are integrally made by woofing. The fabric main body is provided on the surface with an outer sheet layer attached thereto by an adhesive.

### BRIEF DESCRIPTION OF THE DRAWINGS

FIG. 1 shows a perspective view of the fabric main body of the present invention.

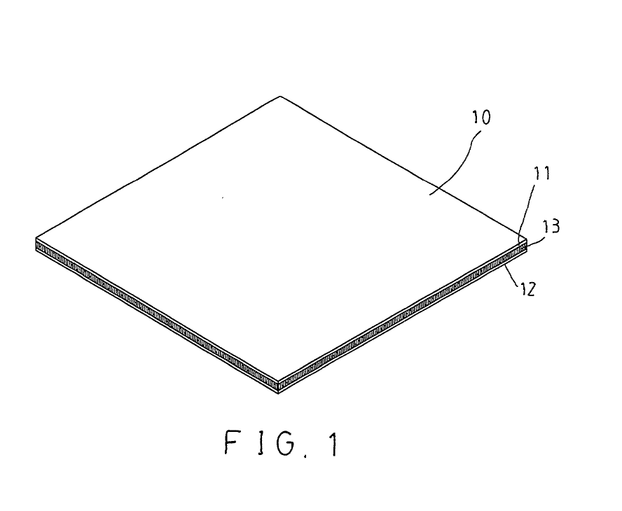

FIG. 2 shows an external perspective view of the present invention.

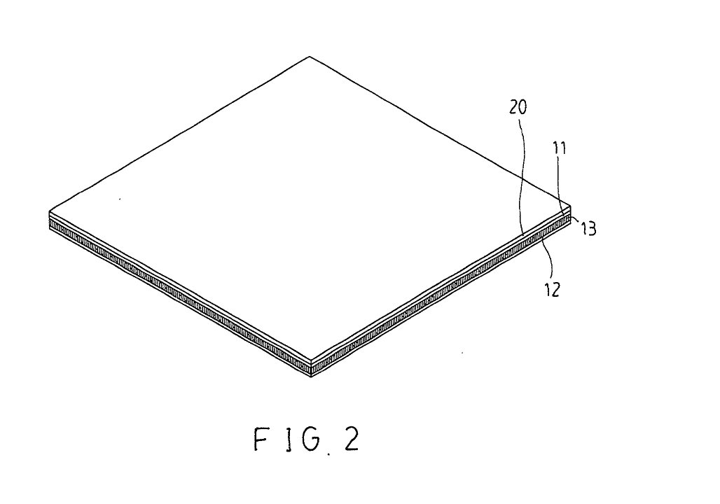

### DETAILED DESCRIPTION OF THE INVENTION

As shown in all drawings provided herewith, a compressible laminated cloth of the present invention comprises a fabric main body 10 and an outer sheet layer 20.

The fabric main body 10 comprises a first sheet layer 11, a second sheet layer 12, and a support layer 13 sandwiched between the first sheet layer 111 and the second sheet layer 12. The first sheet layer, the support layer, and the second sheet layer are integrally made by knitting. The preferred embodiment of the present invention is integrally made by woofing.

The outer sheet layer 20 is a cloth made of any material, or a sheet product of plastic or rubber. The outer sheet layer 20 is adhered to the surface of the fabric main body 10. According to the preferred embodiment of the present invention, the outer sheet layer 20 is attached to the surface of the fabric main body 10 by a plurality of irregular adhesive dots.

The fabric main body of the present invention is made by woofing and is therefore more cost-effective than the conventional fabric which is made by warping. However, the present invention is weaker in textural strength than the conventional fabric. In spite of this disadvantage, the present invention is less susceptible to deteriorating and aging than the foam material. Moreover, the sandwich structure of the present invention is not vulnerable to peeling. The present invention allows a greater versatility in design.

What is claimed is:

1. A compressible laminated cloth comprising:
a fabric main body comprising a first sheet layer, a second sheet layer, and a support layer sandwiched between the first sheet layer and the second sheet layer, said first sheet layer, said support layer, and said second sheet layer being made integrally by woofing; and
an outer layer of a cloth made of any material, or a sheet made of a plastic or rubber material, said outer layer being attached to the surface of said fabric main body.

2. The laminated cloth as defined in claim 1, wherein said outer layer is attached to the surface of said fabric main body by a plurality of adhesive dots.

3. The laminated cloth as defined in claim 2, wherein said outer layer is attached to the surface of said fabric main body by a plurality of irregular adhesive dots.
